(19) United States
(12) Patent Application Publication
(10) Pub. No.: US 2023/0281424 A1
(43) Pub. Date: Sep. 7, 2023

(54) Method for Extracting Features from Data of Traffic Scenario Based on Graph Neural Network

(71) Applicant: Robert Bosch GmbH, Stuttgart (DE)

(72) Inventor: Quanzhe Li, Suzhou (CN)

(21) Appl. No.: 18/146,427

(22) Filed: Dec. 26, 2022

(30) Foreign Application Priority Data
Dec. 29, 2021 (CN) 2021 1168 3649.4

(51) Int. Cl. G06N 3/04; G06N 3/08

(52) U.S. Cl. CPC G06N 3/04; G06N 3/08

(57) ABSTRACT

A method related to the field of environment modeling of traffic scenarios is disclosed. Specifically, a method for extracting features from data of a traffic scenario based on a graph neural network is disclosed. The method includes the following steps: step (S1): establishing uniformly defined data representations for the data of the traffic scenario; step (S2): constructing a graph based on the data of the traffic scenario that has the uniformly defined data representations, where the graph describes a temporal and/or spatial relationship between entities in the traffic scenario; and step (S3): using the constructed graph as an input of the graph neural network to perform learning on the graph neural network, such that the features are extracted from the data of the traffic scenario. A device for extracting features from data of a traffic scenario based on a graph neural network and a computer program product is also disclosed.

This application claims priority under 35 U.S.C. § 119 to Chinese patent application no. 2021 1168 3649.4, filed on Dec. 29, 2021 in China, the disclosure of which is incorporated herein by reference in its entirety.

The present disclosure relates to a method for extracting features from data of a traffic scenario based on a graph neural network, a device for extracting features from data of a traffic scenario based on a graph neural network, and a computer program product.

### BACKGROUND

Currently, deep learning technologies are gaining more and more attention in the field of autonomous driving, and as a powerful tool, they are used to implement various autonomous driving functions, such as perception, prediction, and planning. In a typical application scenario, an environment model of a traffic scenario may be constructed based on a large amount of data of the traffic scenario by using scenario deep learning technologies. However, these data of the traffic scenario are generally collected by different sensors (such as image sensors, lidar sensors, and/or positioning sensors from different suppliers), or even from different data sources (such as sensors, on-board maps, and/or roadside units). As a result, quality and/or specifications of these data differ greatly. Since the deep learning technologies have strict requirements on the quality and/or specifications of data, this undoubtedly has a negative impact on the utilization of the deep learning technologies.

In the past, some methods for extracting features from data sources of a traffic scenario have been proposed, in which these features may be used to construct an environment model of the traffic scenario for motion prediction of a vehicle or vulnerable road users (VRUs) and behavior planning of the vehicle, etc. However, these methods all have limitations in use, either focusing on manually designed model construction and being highly dependent on specific traffic scenarios, or only structurally optimizing effective information extraction.

In this context, it is desired to provide a method for extracting features from data of a traffic scenario based on a graph neural network, so as to make better use of deep learning technologies in environment modeling of a traffic scenario.

### SUMMARY

The present disclosure aims to provide a method for extracting features from data of a traffic scenario based on a graph neural network, a device for extracting features from data of a traffic scenario based on a graph neural network, and a computer program product, so as to solve at least some of the problems in the prior art.

According to a first aspect of the present disclosure, there is provided a method for extracting features from data of a traffic scenario based on a graph neural network, the method including the following steps:

step (S1): establishing uniformly defined data representations for the data of the traffic scenario;

step (S2): constructing a graph based on the data of the traffic scenario that has the uniformly defined data representations, where the graph describes a temporal and/or spatial relationship between entities in the traffic scenario; and

step (S3): using the constructed graph as an input of the graph neural network to perform learning on the graph neural network, such that the features are extracted from the data of the traffic scenario.

The present disclosure especially includes the following technical thought: Uniformly defined data representations are established for data of a traffic scenario with different specifications and/or qualities from different data sources, and a graph is constructed based on the data of the traffic scenario having the uniformly defined data representations, where the graph can describe a temporal and/or spatial relationship between entities in the traffic scenario, and a powerful learning capability of the graph neural network is used to complete feature extraction, so that data modeling with high level of abstraction, high robustness, and high compatibility can be implemented.

In the sense of the present disclosure, “uniformly defined” may be understood as follows: data from different data sources may be represented in a common format, such as points, vectors, boxes, polygons, or segmentation, etc. It should be noted that data represented by points is interchangeable with that represented by vectors. Data may be especially represented in a format with uniform metrics. These data from different data sources may be existing data sets, or may be images or point clouds from sensors (such as image sensors, lidar sensors, and/or positioning sensors) of different suppliers and/or high-precision maps provided by different suppliers, or may be from an output (such as a diagnostic result and an instance segmentation) of different function modules (such as perception, prediction, planning and other modules), or may be from simulation or game data, etc. Optionally, the data representations may include geometric information and annotation information, where the geometric information and the annotation information may be stored together.

It should be noted that deep learning algorithms are very sensitive to data, and differences between qualities and/or specifications of these data may have a negative impact on the performance of the deep learning algorithms. Exemplarily, the definition of bounding boxes may affect the accuracy of prediction algorithms as overlapping parts of vehicles may be included in or excluded from boxes in different specifications. Two different perception modules (for example, sensors provided by different suppliers) have different perception uncertainties, which undoubtedly causes problems when using data from these two perception modules.

Herein, the following advantages are especially achieved: data reconstruction or data reorganization may be implemented only by making minor changes to information of each entity in a traffic scenario, to construct a graph in subsequent method steps.

Optionally, in the constructed graph, nodes of the graph represent entities in the traffic scenario, and edges of the graph represent a temporal and/or spatial relationship between the nodes. The entities in the traffic scenario include driving lane boundaries, traffic lights or traffic signs, traffic participants, obstacles, and/or instances. In the sense of the present disclosure, “a temporal and/or spatial relationship between nodes” includes a temporal relationship between the nodes, a spatial relationship between the nodes, and a temporal and spatial relationship between the nodes.

Optionally, the extracted features may be highly abstract features that may be used to construct an environment model of the traffic scenario.

Optionally, the method further includes the following steps:
step (S4): combining the graph neural network and a deep learning algorithm for another task to form a new neural network, where the features extracted by using the graph neural network are used as an input of the deep learning algorithm for the other task to train the combined new neural network; and
step (S5): optimizing the graph neural network by training the combined new neural network, and returning to step S3.

Optionally, the deep learning algorithm may be a deep learning algorithm for different tasks, where the tasks are especially prediction and planning, and include, but are not limited to, behavior planning, trajectory planning, VRU prediction, agent prediction, and planning based on deep reinforcement learning (DRL). Herein, the deep learning algorithm may be, for example, a convolutional neural network algorithm, a recurrent neural network algorithm, or a graph neural network algorithm.

Herein, the following advantages are especially achieved: the graph neural network may be constructed as a part of the new neural network by training the combined new neural network, and the graph neural network is also optimized while the new neural network is optimized in the process of training by using deep learning algorithms for different tasks, which achieves the purpose of using different deep learning algorithms to optimize the graph neural network algorithm for extracting features. In addition, through cyclic learning based on different tasks, not only the graph neural network is more adaptable to data with different specifications and/or qualities, but also the extracted features have higher level of abstraction, higher robustness, and higher compatibility.

Optionally, the method further includes the following step:
step (SM): adjusting tags of the data of the traffic scenario by using an output of the combined new neural network.

In the sense of the present disclosure, a “tag” may be understood as a tag of data in machine learning (including supervised learning and non-supervised learning), which includes a tag in supervised learning and a tag output by a simulation system in non-supervised learning. In the process of machine learning, a machine learning model may be guided to be trained by using the tag and learn discriminative features.

Herein, the following advantages are especially achieved: The tags of the data of the traffic scenario are adjusted by using the deep learning algorithm, to assist in manual tagging and checking the quality of the manual tagging, thereby improving the data quality and further effectively improving the performance of the deep learning algorithm.

According to a second aspect of the present disclosure, there is provided a device for extracting features from data of a traffic scenario based on a graph neural network, the device being configured to perform the method according to the first aspect of the present disclosure. The device includes:
a data collection and preprocessing module configured to be able to collect data of a traffic scenario from different data sources and establish uniformly defined data representations for the collected data of the traffic scenario;
a graph construction module configured to be able to construct a graph based on the data of the traffic scenario that has the uniformly defined data representations; and a graph neural network module configured to be able to perform learning by using the constructed graph as an input, extract features from the data of the traffic scenario, and use the extracted features as an input to train a deep learning algorithm for another task.

Optionally, the graph neural network module includes a feature extraction module and a deep learning module, where the feature extraction module is configured to extract features from the data of the traffic scenario through learning of the graph neural network, and the deep learning module uses the deep learning algorithm for the other task to optimize the graph neural network algorithm for extracting features.

According to a third aspect of the present disclosure, there is provided a computer program product, including a computer program, where when the computer program is executed by a computer, the method according to the first aspect of the present disclosure is implemented.

### BRIEF DESCRIPTION OF THE DRAWINGS

In the following, the principles, features and advantages of the present disclosure can be better understood by describing the present disclosure in more detail with reference to the accompanying drawings. In the drawings:

FIG. 1 is a flowchart of a method for extracting features from data of a traffic scenario based on a graph neural network according to an exemplary embodiment of the present disclosure;

FIG. 2 is a flowchart of a method for extracting features from data of a traffic scenario based on a graph neural network according to another exemplary embodiment of the present disclosure;

FIG. 3 is a flowchart of a method for extracting features from data of a traffic scenario based on a graph neural network according to another exemplary embodiment of the present disclosure; and

FIG. 4 is a schematic diagram of a device for extracting features from data of a traffic scenario based on a graph neural network according to an exemplary embodiment of the present disclosure.

### DETAILED DESCRIPTION

In order to make the technical problems to be solved by the present disclosure, technical solutions and beneficial technical effects more clear, the present disclosure will be described in further detail below with reference to the drawings and various exemplary embodiments. It should be understood that the specific embodiments described herein are only for the purpose of explaining the present disclosure and are not intended to limit the scope of protection of the present disclosure.

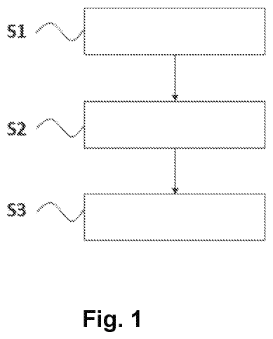

FIG. 1 is a flowchart of a method for extracting features from data of a traffic scenario based on a graph neural network according to an exemplary embodiment of the present disclosure. The method of the present disclosure is described in more detail in the following exemplary embodiment.

In step S1, uniformly defined data representations are established for data of a traffic scenario. Herein, the data of the traffic scenario may be collected from different data sources. Exemplarily, these data of the traffic scenario from different data sources may be existing data sets, or images or point clouds from sensors (such as image sensors, lidar sensors, and/or positioning sensors) of different suppliers and/or high-precision maps provided by different suppliers, or come from an output (such as a diagnostic result and an instance segmentation) of different function modules (such as perception, prediction, planning and other modules), or come from simulation or game data, etc.

In a current embodiment of the present disclosure, the data representations may include geometric information and annotation information, where the geometric information and the annotation information may be stored together. Exemplarily, geometric information of driving lane boundaries may be represented by a series of points or a set of vectors, and positions of the driving lane boundaries may be stored together with the geometric information as annotation information. Geometric information of traffic participants (such as cars, trucks, bicycles, and pedestrians) may be represented by boxes or polygons, and locations and directions of the traffic participants may be stored together with the geometric information as annotation information. Geometric information of traffic lights or traffic signs may be represented by boxes or polygons, and states, meanings, and the like of the traffic lights or traffic signs may be stored together with the geometric information as annotation information.

In step S2, a graph is constructed based on the data of the traffic scenario that has the uniformly defined data representations, where the graph describes a temporal and/or spatial relationship between entities in the traffic scenario. In a current embodiment of the present disclosure, in the constructed graph, nodes of the graph represent entities in the traffic scenario, and edges of the graph represent a temporal and/or spatial relationship between the nodes, where the relationship includes a temporal relationship between the nodes, a spatial relationship between the nodes, and a temporal and spatial relationship between the nodes. The entities in the traffic scenario may include, for example, driving lane boundaries, traffic lights or traffic signs, traffic participants, obstacles, and/or instances. Exemplarily, information such as a distance between two vehicles, positions of the vehicles, and a speed difference between the vehicles may describe the spatial relationship between the nodes. The solid and dashed driving lane boundaries describe a spatial relationship between potential driving behaviors of vehicles. Information of about traffic lights or traffic signs defines lawful driving behaviors of vehicles in time and/or space, for example, in which time period and in which driving lane a vehicle is allowed to travel. In addition, a temporal relationship between nodes may be established according to different time steps, for example, position change information of a vehicle as a function of a time change process when the vehicle travels through an intersection, etc.

In step S3, the constructed graph is used as an input of the graph neural network to perform learning on the graph neural network, such that the features are extracted from the data of the traffic scenario. In a current embodiment of the present disclosure, the extracted features are especially highly abstract features used to construct an environment model of the traffic scenario.

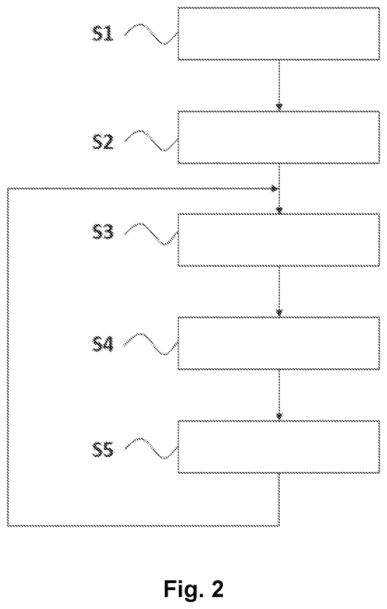

FIG. 2 is a flowchart of a method for extracting features from data of a traffic scenario based on a graph neural network according to another exemplary embodiment of the present disclosure. Only differences between the embodiment illustrated in this figure and the embodiment illustrated in FIG. 1 are explained below, and the same steps are not described repeatedly for the sake of brevity. In the embodiment, the method further includes steps S4 and S5.

In step S4, the graph neural network and a deep learning network for another task are combined to form a new neural network. Herein, a process of end-to-end training from the graph constructed in step S2 to the other task is designed, in which a deep learning module may be configured to perform deep learning algorithms for various different tasks and includes a plurality of layers. Each task may correspond to different deep learning methods, such as a convolutional neural network algorithm, a recurrent neural network algorithm, and/or a graph neural network algorithm. In addition, the deep learning algorithm may be used for different tasks, where the tasks are especially prediction and planning, and include, but are not limited to, behavior planning, trajectory planning, VRU prediction, agent prediction, and planning based on DRL. Therefore, data of different traffic scenarios may be deeply learned by using deep learning algorithms for different tasks.

In step S5, the graph neural network is optimized by training the combined neural network, and returning to step S3 is performed, so that the optimized graph neural network may be used to extract features. Herein, an output of the combined new neural network is a task to which the deep learning algorithm participating in the combination is applicable. For example, the deep learning algorithm participating in the combination is used to predict pedestrian trajectories, so that the output of the combined new neural network is a pedestrian trajectory. When output pedestrian trajectories show that the performance is improved, the graph neural network may be optimized, returning to step S3 may be performed, and the optimized graph neural network may be used to extract features.

In the embodiment, different tasks and corresponding deep learning algorithms may be selected, and the target graph neural network may be optimized by continuous learning in a cyclic manner, so that more information may be obtained from learning results that are obtained by using a plurality of algorithms in a combined manner, and features with higher level of abstraction, robustness, and compatibility may be extracted.

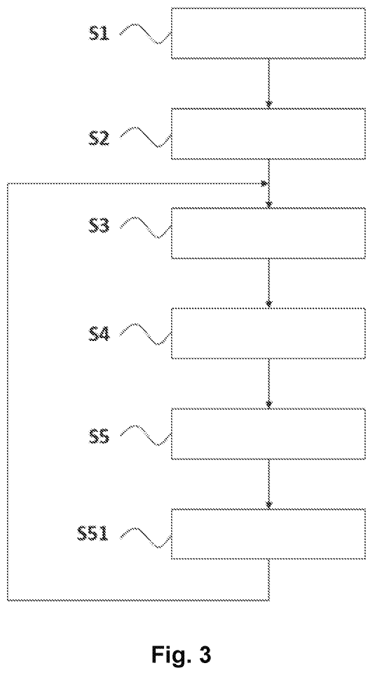

FIG. 3 is a flowchart of a method for extracting features from data of a traffic scenario based on a graph neural network according to another exemplary embodiment of the present disclosure. Only differences between the embodiment illustrated in this figure and the embodiment illustrated in FIG. 2 are explained below, and the same steps are not described repeatedly for the sake of brevity. In the embodiment, the method further includes step SM.

In step S51, tags of the data of the traffic scenario are adjusted by using an output of the combined new neural network. Specifically, if an output result of a deep learning algorithm corresponding to a specific task shows that performance of the deep learning algorithm is improved in steps S4 and S5, information may be extracted from the output of the algorithm to form a tag. Data tagging may be assisted by using the tags, so as to implement, for example, automatic pre-tagging of tags, error correction of tags, and the like.

It should be noted that, in a conventional deep learning method, it is usually necessary to perform tagging by using a manual tagging method or other assistant algorithms, while in a current embodiment of the present disclosure, tagging may be optimized more effectively with the help of information extracted from deep learning results, thereby improving the data quality, and further effectively improving the performance of the deep learning algorithm.

It should be noted that the sequence numbers of the steps described herein do not necessarily represent a sequence, but are merely reference signs, and the sequence may be changed according to specific conditions, as long as the technical purpose of the present disclosure can be achieved.

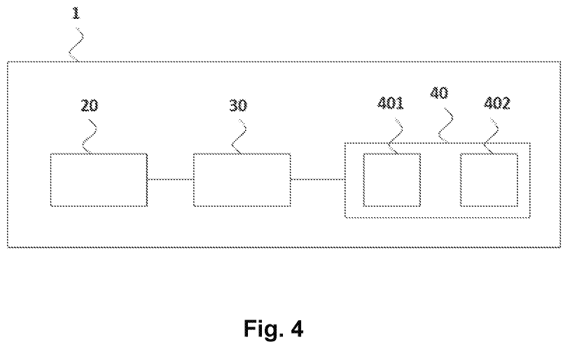

FIG. 4 is a schematic diagram of a device for extracting features from data of a traffic scenario based on a graph neural network according to an exemplary embodiment of the present disclosure.

As shown in FIG. 4, a device 1 includes a data collection and preprocessing module 20, a graph construction module 30, and a graph neural network module 40. Herein, the data collection and preprocessing module 20 is configured to be able to collect data of a traffic scenario from different data sources and establish uniformly defined data representations for the collected data of the traffic scenario. The graph construction module 30 is configured to be able to construct a graph based on the data of the traffic scenario that has the uniformly defined data representations. The graph neural network module 40 is configured to be able to store the constructed graph, extract features from the data of the traffic scenario, and use a deep learning algorithm for another task to optimize an algorithm (that is, a graph neural network algorithm) for extracting features.

Specifically, the graph neural network module 40 includes a feature extraction module 401 and a deep learning module 402, where the feature extraction module 401 is configured to extract features from the data of the traffic scenario through learning of the graph neural network, and the deep learning module 402 uses the deep learning algorithm for the other task to optimize the graph neural network algorithm for extracting features.

Although specific embodiments of the present disclosure have been described in detail herein, they are given for the purpose of explanation only and should not be considered as limiting the scope of the present disclosure. Various substitutions, alterations and modifications may be devised without departing from the spirit and scope of the present disclosure.

What is claimed is:

1. A method for extracting features from data of a traffic scenario based on a graph neural network, comprising:
(a) establishing uniformly defined data representations for the data of the traffic scenario;
(b) constructing a graph based on the data of the traffic scenario that has the uniformly defined data representations, wherein the graph describes a temporal and/or spatial relationship between entities in the traffic scenario; and
(c) using the constructed graph as an input of the graph neural network to perform learning on the graph neural network such that the features are extracted from the data of the traffic scenario.

2. The method as claimed in claim 1, wherein the method further comprises:
(d) combining the graph neural network and a deep learning algorithm for another task to form a new neural network, wherein the features extracted by using the graph neural network are used as an input of the deep learning algorithm for the other task to train the combined new neural network; and
(e) optimizing the graph neural network by training the combined new neural network, and returning to step (c).

3. The method as claimed in claim 2, wherein the method further comprises:
(f) adjusting tags of the data of the traffic scenario by using an output of the combined new neural network.

4. The method as claimed in claim 1, wherein:
the data representations comprise geometric information and annotation information, and
the geometric information and the annotation information are configured to be stored together.

5. The method as claimed in claim 1, wherein:
nodes of the graph represent the entities in the traffic scenario, and
edges of the graph represent a temporal and/or spatial relationship between the nodes.

6. The method as claimed in claim 1, wherein the entities in the traffic scenario include driving lane boundaries, traffic lights or traffic signs, traffic participants, obstacles, and/or instances.

7. The method as claimed in claim 2, wherein the deep learning algorithm is a deep learning algorithm for different tasks.

8. The method as claimed in claim 2, wherein the deep learning algorithm is a convolutional neural network algorithm, a recurrent neural network algorithm, and/or a graph neural network algorithm.

9. The method as claimed in claim 1, wherein in step (c), the extracted features are highly abstract features used to construct an environment model of the traffic scenario.

10. A device for extracting features from data of a traffic scenario based on a graph neural network, the device being configured to perform the method as claimed in claim 1, and the device comprising:
a data collection and preprocessing module configured to collect data of a traffic scenario from different data sources and establish uniformly defined data representations for the collected data of the traffic scenario;
a graph construction module configured to construct a graph based on the data of the traffic scenario that has the uniformly defined data representations; and
a graph neural network module configured to store the constructed graph, extract features from the data of the traffic scenario, and use a deep learning algorithm for another task to optimize a graph neural network algorithm for extracting features.

11. The device as claimed in claim 10, wherein:
the graph neural network module comprises a feature extraction module and a deep learning module,
the feature extraction module is configured to extract features from the data of the traffic scenario through learning of the graph neural network, and
the deep learning module is configured to use the deep learning algorithm for the other task to optimize the graph neural network algorithm for extracting features.

12. A computer program product, comprising a computer program, wherein when the computer program is executed by a computer, the method as claimed in claim 1 is implemented.

13. The method as claimed in claim 7, wherein the tasks are prediction and planning, and comprise behavior planning, trajectory planning, VRU prediction, agent prediction, and planning based on DRL.
